(19) United States
(12) Patent Application Publication
(10) Pub. No.: US 2015/0026146 A1
(43) Pub. Date: Jan. 22, 2015

(54) SYSTEM AND METHOD FOR APPLYING A SET OF ACTIONS TO ONE OR MORE OBJECTS AND INTERACTING WITH THE RESULTS

(71) Applicant: DANIEL IVAN MANCE, BURLINGTON (CA)

(72) Inventor: DANIEL IVAN MANCE, BURLINGTON (CA)

(21) Appl. No.: 14/333,818

(22) Filed: Jul. 17, 2014

Related U.S. Application Data
(60) Provisional application No. 61/847,333, filed on Jul. 17, 2013.

(51) Int. Cl. G06F 17/30; G06F 3/0484

(52) U.S. Cl. CPC G06F 17/30991; G06F 3/04842
USPC 707/706

(57) ABSTRACT

An Internet search computer system is provided that includes a computer network service environment that includes a search input utility that initiates the presentation on a display linked to a client device of a search interface; the search input utility allowing one or more users to select one or more search objects, and optionally collecting search input from the one or more users. The search engine utility is configured to iteratively process the search objects and/or search input so as to identify a plurality of suggested actions that are responsive to the search objects and/or search input, for further selection by the one or more users. The computer network service environment initiates the automatic processing of the search objects and search input, and iteratively updates suggested actions with the results of such processing. The computer network service environment analyzes the search objects and search input and matches the results of such analysis to applications and related application functions so as to generate the results.

### CROSS-REFERENCE TO RELATED APPLICATIONS

This application claims the benefit of U.S. Provisional Patent Application No. 61/847,333, filed Jul. 17, 2013, the contents of which are hereby incorporated by reference in its entirety.

### FIELD OF THE INVENTION

This invention relates generally to Internet search, and computer systems for processing information. This invention further relates to application discovery that may include aggregating results from multiple web services, and displaying virtual desktops and applications.

### BACKGROUND

The Internet contains a vast amount of information, distributed over a multitude of interconnected computers, however, finding the desired information is not always easy or fast.

Search engines have been developed to address the problem of finding desired information on the Internet. Typically, a user who has an idea of the type of information desired, enters a search term or search terms, and a search engine returns a list of web pages that contain the term or terms. Alternately, a user may want to browse through data, as for example when a user is not sure what information is wanted.

Web search constitutes one of the most used Internet applications and is associated with substantial advertisement revenues. Results to web search queries are typically influenced by several metrics: 1) content relevance derived from documents' anchor text, title and headings, word frequency and proximity; file, directory, and domain names, and other more sophisticated forms of content analysis; 2) user behavior extrapolated from user's spent time-on-page, time-on-domain, click-through rates, etc.; and 3) popularity in the global link structure with authority, readability, and novelty typically determining the linkage.

With current practices, links to the most “relevant” web pages according to the above criteria may be clustered and delivered to users who in turn browse the results to find the desired information. An important problem with prior art web search technologies is content redundancy: existing search engines often return unsatisfactory results as they consider the query coverage by each page individually, not a set of pages as a whole.

Some Internet search technologies exist where the user specifies text or a web page or a media object, and the search engine applies a specific set of transforms or processing to provide the result.

The Google™ search engine is generally dependent on canned processing of its caches and indices of the Internet, and search results are generated for a limited number of select object types.

The Google™ search engine uses natural language processing on textual phrases (for example metric conversion and text-to-speech). It also applies automatic processing on images (image search), sounds (speech-to-text), audio (find name of song) and also on video. Another example technology is Google™ Translate where a user enters a text string that the website converts to a language of choice and provides to the user as either text or spoken-word audio.

However, actions—in the form of specific automated processing—are applied to a relatively narrow set of object types recognized by the system. For specialized or less-common object types, the Google™ search engine reverts to ordinary text-based search results.

Another known prior art solution is Wolfram Alpha™, which is a computational search engine that applies actions to phrases. Phrases may include for example an object such as a geographic location such as Waterloo, Ontario. The object is analyzed and related information is returned such as geographic, political, and demographic data. Wolfram Alpha™ also allows the upload of image objects and access filters, histograms and other tools to generate and display known attributes and/or common characteristics associated with the image, or image type represented by the image. Also supported are the upload of audio objects, and analysis/processing by common audio waveform filters. Wolfram Alpha™ provides more comprehensive processing, but also is limited by use on select objects.

The prior art solutions attempt to arrive at a pre-determined solution that in many cases will not reflect user intent because the objects sought by the user is not considered within their purview (e.g., is an unsupported or unrecognized type of object).

Further, searches using prior art solutions are generally limited to text strings and return results in a similar manner. The user must read through the responses and visit/download/evaluate each for suitability. A limited filter is applied in that the results are ranked by the search engine, but that ordering may be separate and distinct from the user's requirements.

Searches are limited by the quality of the text strings inputted by users. Subscribers wanting to perform certain tasks may not even know the technical term for what they are trying to do, and must make multiple attempts to obtain the right spectrum of answers. Even when they find a solution, multiple steps may be required to fully implement it and get the desired result.

The above noted problems and limitations associated with prior art solutions are especially pronounced when a user is searching for software applications (also referred to as software solutions), such as, for example, software applications for creating, processing or transforming a data object. The process of finding suitable software applications/solutions may be referred to as “application discovery”.

Users may have knowledge of and experience with processing certain types of data objects. For such familiar types of data objects, the user may have access to pre-installed applications/solutions (e.g., provided on the user's personal laptop/desktop or via a corporate network). The user may also have familiarity with and ready access to other software applications/solutions in the trade. However, given the rapid pace of change in technology, workplace IT environments, and application currencies, solutions familiar and available to the user may become limiting, deprecated, or otherwise unsatisfactory. For example, as data objects types get older or become marginalized by industry disuse and competition, or through accelerating adoption of newer formats, a search for newer applications/solutions to support newer data object types or data formats may be required.

Typically, the user must search amongst software presented on various Internet webpages. As noted, searches are often limited to text strings (e.g., relating to software functionality). A large number of responses of varying relevance may be returned.

The user must sequentially evaluate each of the responses, a potentially time-consuming and tedious task. Upon identifying a candidate webpage, the web-served or download-served software provided by the candidate webpage must be obtained and evaluated (typically requiring registration or even purchase), the user must install it, possibly requiring administrative privileges (which they may not have) and/or risking the installation of malware. Further, the user may not have appropriate or sufficient computing resources to install and/or execute the software, e.g., when the user is using a low-resource device such as, for example, a netbook, tablet computer, or the like.

Once the software is installed and operational, the suitability or viability of the solution may be reviewed through interaction of the software with the user's data object, e.g., to process/transform the user's data object. This may require the data object to be uploaded or otherwise transmitted to a website (in the case of a web service). Alternatively, if the users' data object is stored in the cloud, the data object may need to be retrieved to the local system on which the software is installed.

The process is repeated through all candidate webpages until a solution is found.

The user is faced with:

1. A trial and error process of searching the Internet for possible solutions, downloading related software, testing, and evaluating the results.

2. Developing their own solution with either custom software or software already installed on their system or otherwise known. This may require domain specific knowledge to attempt (or a lot of auxiliary reading and learning).

3. Searching the Internet for related problems in an attempt to form the search query for the original problem in such a way as to provide relevant information.

4. Testing each solution found, evaluating first based on accessibility and readability, then availability of required supporting software. Solutions found may be out of date, incompatible, irrelevant, incomplete, or too complicated. Solution evaluation may be further complicated when trying to compare solutions “side-by-side”.

5. If the solution must be applied to a large number of objects, the user must either write a script to automate the process (more custom software) or perform the sequence manually, one object at a time.

More advanced transformations/processing of content (data) require at least two of discovery, installation and operation of an appropriate application. Direct transformation/processing of complex data is not possible within the web pages of prior art Internet search technologies.

So, transforming/processing data is more commonly achieved through the use of mobile and desktop applications (which may be collectively referred to as “Apps”), in which case the App must be downloaded, installed and tested. Increasingly, there are instances where Apps are built into a web page (using technologies such as HTML5 and Javascript) and utilize “cloud” technologies for computing and storage.

Apps may also be executable programs bundled with the operating system or scripts written by the user or another party that utilize the power of the operating system. Apps may also be third-party tools purchased through traditional “bricks and mortar” stores, downloaded from a public website (typically a software aggregator), downloaded from the commercial website of the App publisher, or retrieved from an “App Store”. These third-party Apps need to be installed (in some fashion) prior to operation.

Apps may also be realized as web-services that are accessed through an API (application programming interface) in a non-interactive (headless) environment.

Before a user can use an App, it must first be discovered, either on the local device, or in the wider Internet. Typically, for an App that is completely unknown, this involves a search via a conventional search engine to find the name and location of a possible candidate based on the user's data object in question (e.g., the data object to be transformed/processed) and keywords specific to the task (in a trivial example case, say, bitmap image format conversion). The user would then browse the software offerings—making their decision based on descriptive information from the publisher, product reviews, blogs and finally attempting the download, installation/configuration and evaluation. These tasks are rather manual and can be complicated; more so if the knowledge of the user is limited or aspects of device, software platform or media format incompatibilities cause problems.

Given the vast number of Apps in existence, there are programs available to assist the user in finding the App by helping to narrow the search through cross-referencing multiple app-stores, providing user-community suggestions and feedback. These are helpful; however none provide a means to directly assist the user in the process of actually installing, configuring and engaging with the App.

For almost any problem, there is a wealth of generally available open-source, demonstration, and commercial software. Most of it can be found on-line through one of the search engines; however, using any of them may require a leap of faith. Such software is often unproven and may be a source of computer viruses, wrong purpose, unsupported/abandoned or non-functional features. Search engines find thousands of references, but provide little guidance as to which of those is the most useful, other than the position in the list. There is no indication that the reference is current/active, or the potential level of risk involved in using it.

There are also multiple solutions to problems through scripting tools such as Microsoft's PowerShell™, allowing a user to perform a complex set of commands against multiple objects. However, scripting solutions require significant knowledge and skill on the part of the user to either develop a custom script to suit the task, or search for and select an appropriate script from someone who has already solved this particular problem.

Third-party Apps could be used to enhance web search and address some of the limitations listed above, but third-party Apps are limited use for this purpose because of the limitations thereof listed above, and in particular multiple steps involved in discovering, installing, and operating third-party Apps.

Further, the Apps do not present themselves to the user as realized solutions—only as links to tools that the user must obtain and apply to their problem (data object and keywords). This greatly hinders application discovery.

There is a need for technology solutions that address at least some of the limitations of Internet search previously described. There is also a need for technology solutions that address at least some of the limitations of application discovery previously described.

### SUMMARY

In a broad aspect, an Internet search computer system is provided comprising: a computer network service environment, comprising at least one server computer and a server application, the server computer being configured to process Internet search requests from one or more client devices, the computer network service environment comprising: (i) a search input utility that initiates the presentation on a display linked to a client device of a search interface; the search input utility allowing one or more users to select one or more search objects, and optionally collecting search input from the one or more users; and (ii) a search engine utility configured to iteratively process the search objects and/or search input so as to identify a plurality of suggested actions that are responsive to the search objects and/or search input, for further selection by the one or more users, the computer network service environment being configured to initiate the automatic processing of the search objects and search input, and iteratively update suggested actions with the results of such processing.

In another aspect, the computer network service environment presents the actions in a plurality of sections of the search interface. In a still other aspect, the computer network service environment is linked to an application repository, and the computer network service environment processes the search objects and search input so as to select one or more applications from the application repository for processing the search objects and search input and providing results responsive to the Internet search requests.

In yet another aspect, the computer network service environment matches the search objects and/or search input to applications.

In a further aspect, the computer network service environment matches the search objects and/or search input to specific features of applications.

In a still other aspect, the computer network service includes resources to virtualize one or more applications for presenting the results.

In another aspect, the computer network service environment performs at least one action of the plurality of suggested actions.

In yet another aspect, the computer network service environment performs the at least one action in response to a user section of that at least one action.

In a further aspect, the computer network service environment performs the at least one action automatically.

In a still other aspect, the computer network service environment performs actions of the plurality of suggested actions according to a pre-defined sequence.

In another aspect, the computer network service environment performs actions of the plurality of suggested actions in parallel.

In yet another aspect, the computer network service environment presents an output of performing the at least one action to the one or more users.

In a further aspect, the search engine utility comprises an inference engine configured to process the search objects and/or search input to infer a probable intention of the one or more users.

In a still other aspect, the search objects include at least one of a computer file, a set of computer files, an information organization structure, a data stream, and an identifier of device.

In another aspect, the search engine utility is configured to process search input that specifies a desired operation to be performed on the at least one of the search objects.

In yet another aspect, the search engine utility processes a search object that is a computer file by analyzing at least one of: a file type, a file size, a file storage location, a file name, a file extension, a file header, and a file system attribute.

In another broad aspect, a computer-implemented method of performing an Internet search is provided. The method includes: receiving, at at least one processor, a request to conduct an Internet search from a client device; presenting, to the client device, a user interface allowing a user to select one or more search objects; receiving a user selection of the one or more search objects; processing, at the at least one processor, the selected search objects to identify a plurality of suggested actions that are responsive to the search objects; and presenting, to the client device, a user interface allowing the user to select one or more of the plurality of suggested actions.

In another aspect, the computer-implemented method further includes receiving user input associated with the one or more search objects; wherein identifying the plurality of suggested actions comprises processing the received user input.

In yet another aspect, the search objects include at least one of a computer file, a set of computer files, an information organization structure, a data stream, an identifier of device.

In a further aspect, the processing comprises inferring a probable intention of the one or more users.

In a still other aspect, the computer-implemented method further includes performing the selected one or more actions of the plurality of suggested actions.

In another aspect, the computer-implemented method further includes: presenting, to the client device, an output of performing the selected one or more actions.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood and objects of the invention will become apparent when consideration is given to the following detailed description thereof. Such description makes reference to the annexed drawings wherein:

FIG. 1 is a system diagram illustrating components of the present invention, in one representative implementation thereof;

FIG. 2 a schematic diagram of a server of FIG. 1;

FIG. 3 is system diagram illustrating components of the present invention, including a client application, in one representative implementation thereof;

FIG. 4 is a diagram illustrating a possible design of the search interface of the present invention and also a system workflow in accordance with the present invention;

FIG. 5 is a workflow diagram illustrating in greater detail a possible system workflow in accordance with one aspect of the present invention; and

FIG. 6 illustrates chaining of actions in accordance with another possible aspect of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

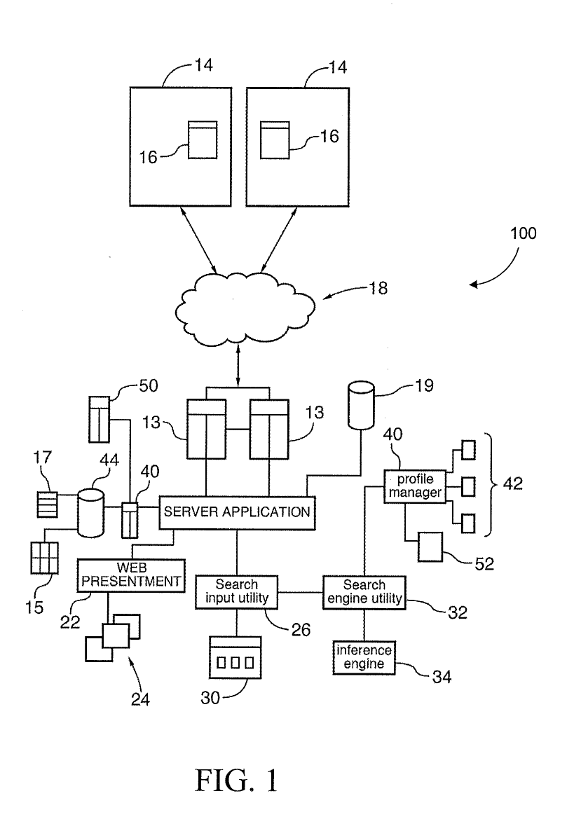

A novel and innovative Internet search computer system (the “computer system”) (10) and computer implemented method is provided. As shown in FIG. 1, the computer system (10) implements a server computer environment (12) that interoperates with one or more client environments (14), in order to provide improved search functionality. The client environment (14) may consist of any manner of computer network device or “client device” (16), connected to a network (18). The server computer environment (12) is implemented to support search operations initiated by a user using the computer network device (16) via the network (18).

Network (18) may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In one implementation, the server computer environment (12) includes one or more server computers (13) (or a server farm) and a server application (20) or application repository. The server application (20) includes a web presentment utility (22) that is operable to serve one or more web pages (24) to the client devices (16). These web pages (24) are based on the search functions and features described herein.

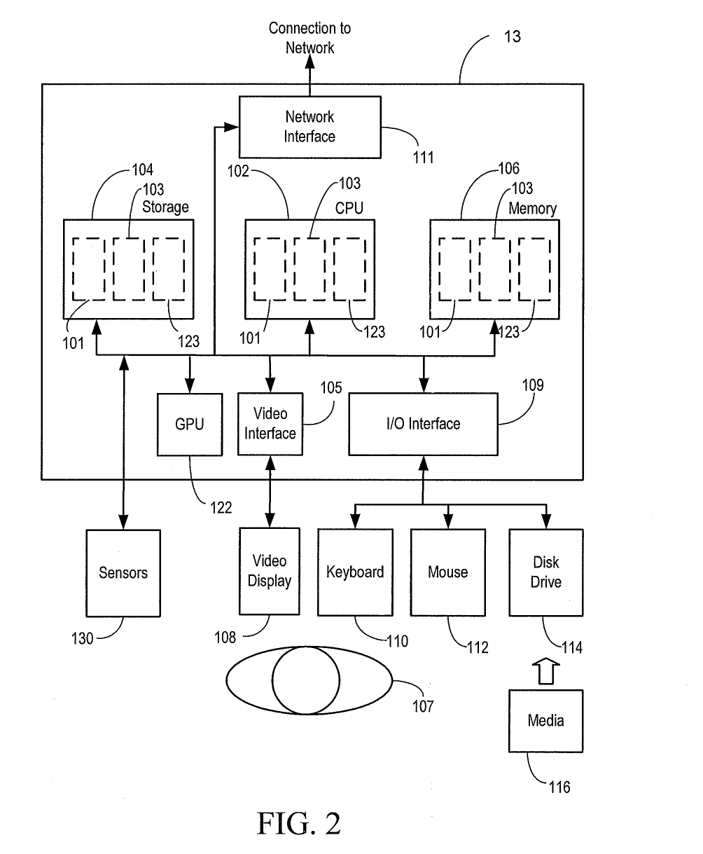

FIG. 2 schematically illustrates a server computer (13), in accordance with one example embodiment of the present invention. As shown, the server computer (13) may include at least one central processing unit (“CPU”) (102) connected to a storage unit (104) and to memory (106).

CPU (102) may be any type of processor, such as, for example, any type of general-purpose microprocessor or microcontroller (e.g., an Intel™ x86, PowerPC™, ARM™ processor, or the like), a digital signal processing (DSP) processor, an integrated circuit, a programmable read-only memory (PROM), or any combination thereof.

Storage unit (104) may include one or more storage devices such as a hard disk, solid-state disk, or the like. Storage unit (104) may also be partly or wholly cloud-based, accessible via a network such as network (18).

Memory (106) may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

The CPU (102) may process an operating system (101), applications (103), including the server application (20) or the application repository, and data (123). Data (123) may include data corresponding to the one or more web pages (24). The operating system (101), applications (103), and data (123) may be stored in storage unit (104) and loaded into memory (106), as may be required. Operating software (101) may, for example, be a Microsoft Windows™, Unix™ Linux™, OSX™ operating system or the like.

Server application (20) and data (123), when processed at CPU (102), provide the functionality of the server computing environment (12) described herein, as further detailed below. Server application (20) and any components thereof may each be implemented in a high level procedural or object oriented programming or scripting language, or both. However, alternatively server application (20) and any components thereof may each be implemented in assembly or machine language, if desired. The language may be a compiled or interpreted language.

The server computer (13) may further include a graphics processing unit (GPU) 122 which is operatively connected to CPU (102) and to memory (106) to offload intensive image processing calculations from CPU (102) and run these calculations in parallel with CPU (102).

An operator (107) may interact with the server computer (13) using a video display (108) connected by a video interface (105), and various input/output devices such as a keyboard (110), mouse (112), and disk drive (114) connected by an I/O interface (109). In known manners, mouse (112) may be configured to control movement of a cursor in video display (108), and to operate various graphical user interface (GUI) controls appearing in the video display (108) with a mouse button. Disk drive (114) may be configured to accept computer readable media (116).

The server computer (13) may connect to one or more networks such as network (8) via network interface (111). Network interface (111) allows the server computer (13) to communicate by way of wired or wireless communications with other computing devices such as client devices (16) by way of network (18) (FIG. 1).

The server computer (13) may be embodied in various form factors including one or more desktop and laptop computers, and wireless mobile computer devices such as tablets, smart phones and super phones. It will be appreciated that the present description does not limit the size or form factor of the computing device on which the present system and method may be embodied.

Each client device (16) may be a conventional computing device configured to connect with and access services provided by other computing devices by way of a network, e.g., server computer (13) by way of network (18). Each client device (16) may include a processor, network interface, display, and memory, allowing the device to execute a conventional browser such as Microsoft Internet Explorer, Mozilla Firefox, Google Chrome, Apple Safari, or the like. In some embodiments, some or all of the client devices (16) may have an architecture similar to that shown for server computer (13) in FIG. 2. So, each client device (16) may be a desktop computer, a laptop computer, a netbook computer, a tablet computer, a personal digital assistance, a smart phone, or the like. Although two client devices (16) are depicted in FIG. 1, there may be any number of client devices, all of which may be serviced concurrently by one or more server computers (13).

Referring again to FIG. 1, in one aspect, the server application (20) defines a search input utility (26). Users of client devices (16) may interact with the search input utility (26) by means of one or more of the web pages (24) presented to client device (16) and displayed on a display (28) of the client device (16), such as computer screen or mobile device screen. The web pages (24) related to the search input utility (26) define a search interface (30), implemented as a graphical user interface (“GUI”). The search input utility (26) is used to allow users to select one or more “search objects” (as explained below) and optionally collect search input from users, which is then processed iteratively by the search engine utility (32), as described below.

The search objects and/or search input are processed by the computer system so as to identify one or more suggested “actions” that are responsive to the search objects and/or search input. Usually the computer system will suggest a plurality of actions. As further explained below the actions, in one aspect of present invention, consist of the results of processing operations by applications invoked by the computer system, using the search object(s) and optionally the search input. In one aspect of the computer system, in response to one or more users selecting one or more search objects, and optionally providing search input, the computer system (A) analyzes the search object(s) and/or search input, (B) based on the analysis identifies one or more applications associated with the computer system, or application features thereof, for processing the search object(s) and/or search input, (C) invokes the one or more applications, or application features thereof, to process the search object(s) and/or search input, and (D) displays the results of such processing as a series of search results in a search interface (“displayed results”). The user may (F) select one or more of the displayed results, which may trigger further processing of the search object(s) and/or search input.

As previously described, prior art is known when search input is provided, mapped operations are automatically triggered, and the results thereof are displayed, along with other search results.

In accordance with the present invention, however, a plurality of possible actions are suggested, run in parallel, and results are presented to the user. Prior art solutions generally assume a single set of “right” results. These results reflect a probabilistic analysis of user intent, which in many cases is incorrect and therefore useless. The present invention, on the other hand, presents a series of possible results specific to the search object(s) and/or search input, and allows the user to choose results that conform to their intention, and in fact allows the user the flexibility to change their intended course of action. The present invention therefore enables much more useful and responsive interactions with a computer network search service.

In another implementation of the computer system of the present invention, a thin application is installed on the client devices (16) to facilitate improved interaction with the server (13) and improved results presentation. Such a thin application allows results to be displayed as virtual applications, as further detailed below.

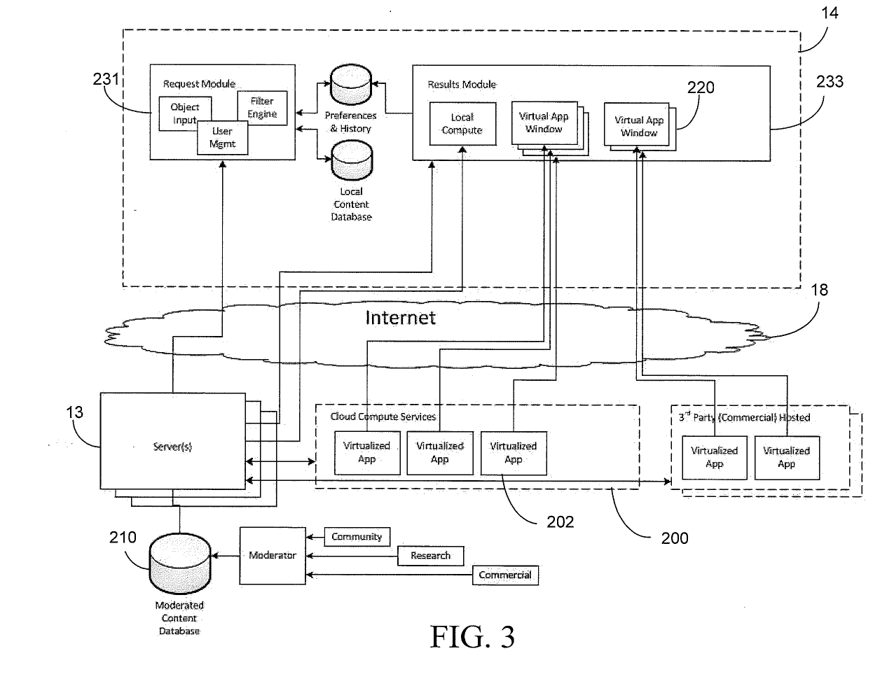

As shown in FIG. 3, the computer system includes a request module (231) and a results module (233), implemented on a client device (14). The client device (14) connects to cloud resources (200) that include virtualized applications (202), and optionally a moderated content database (210). Results are returned to the client in the form of virtual application windows (220).

In another aspect of the present invention, the computer system may be linked to a plurality of vendors through their various applications or computer network services (e.g., web services). The present invention therefore is not limited to the knowledge base of a single vendor, as is generally the case with prior art solutions. The present invention assumes that numerous possible actions may be applicable and that many vendors can propose solutions, and provides a framework within which users can determine easily and efficiently what constitutes a “good” solution for the problem they are attempting to solve.

The prior art solutions assume a “correct” or “complete” solution. In contrast, the present invention allows users to arrive at a preferred solution through experimentation and discovery.

Prior art solutions are directed at providing “free” and “quick” solutions that may be of limited quality. The present invention provides a range of options, that may be run in parallel, and the computer system may display parameters associated with particular options such as time required to completion, costs associated with obtaining results (if there is a fee associated with obtaining results for example from a particular computer network service), a user ranking associated with the service, or other parameters. The user is given the freedom to decide that waiting for a different solution, or paying a fee for a specific solution, represents the best solution for the user, at this time.

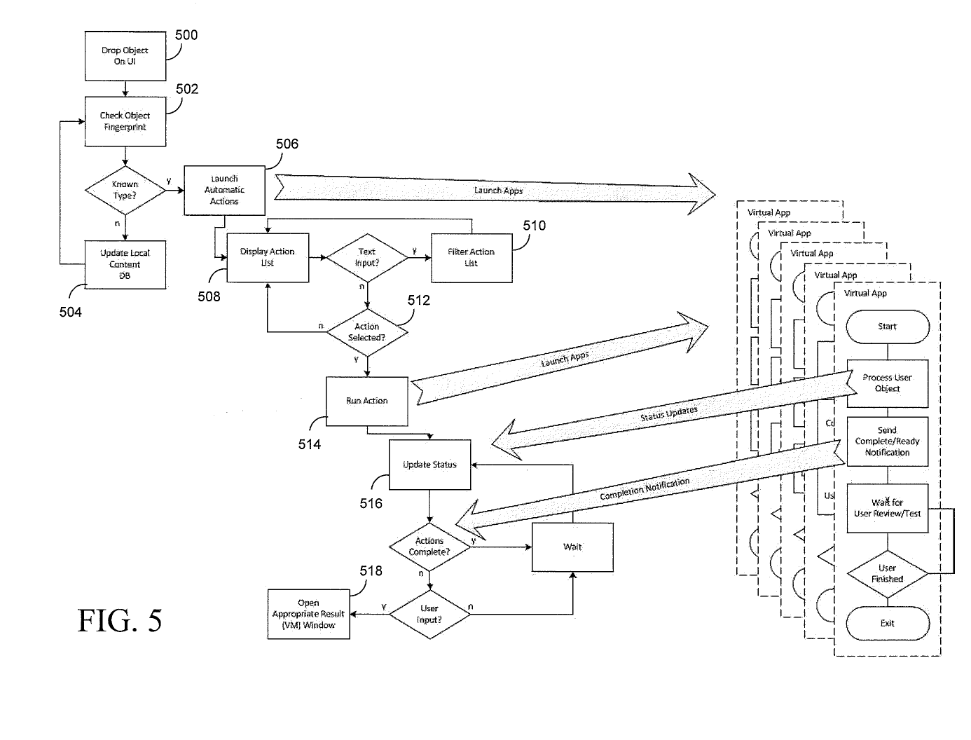

The present invention may be implemented as a multi-level system and workflow, where one or more selections by a user of displayed results, triggers further analysis, and display of a new set of displayed results. Aspects of a possible system workflow implemented by the computer system of the present invention is illustrated in FIG. 5 and further detailed below.

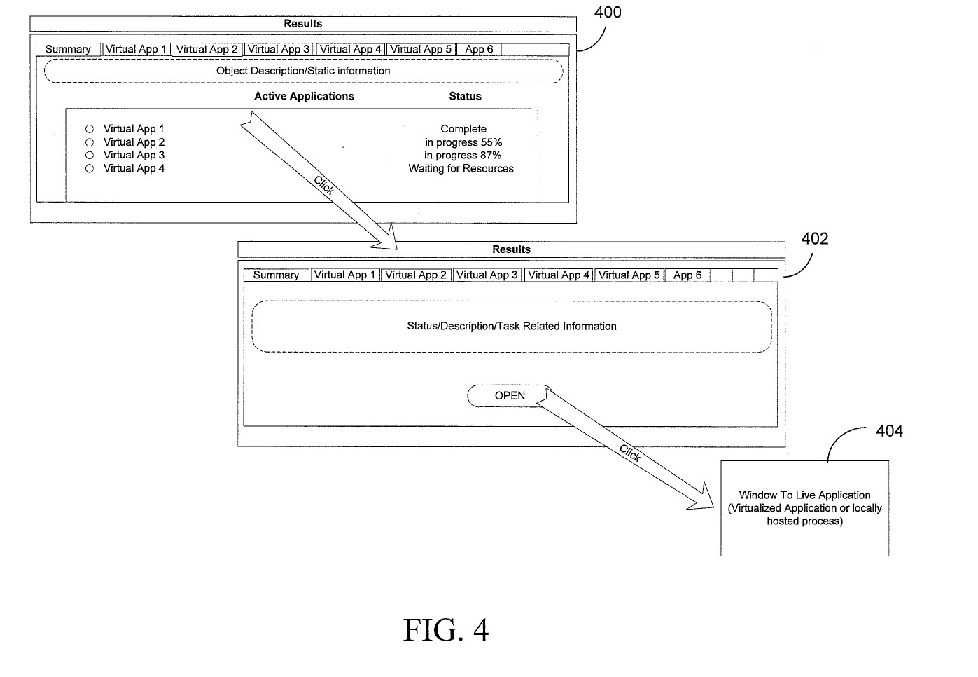

The display of multiple actions enables a series of new, innovative, and useful processes and user workflows. In one aspect of the computer system, a user can review the results of suggested actions across multiple sections of a user interface (for example multiple windows as shown in FIG. 4). As shown in FIG. 4 at (400), the user interface may display a summary panel indicating a initialization progress (e.g., including downloading and virtualization) for each result. As shown at (402), each result may be shown as a separate tab of a results window. The user can quickly and efficiently see multiple scenarios presented by acting on the information provided by the user to the computer network service of the present invention. The user may select one or more of such multiple scenarios for further processing, e.g., to launch a virtual application or locally-hosted process at (404).

Conveniently, providing a user interface that allows results to be presented simultaneously (e.g., in separate tabs or in separate panels) allows a user to scan multiple applications simultaneously and rapidly compare those applications. This may especially improve the efficiency of comparisons on the basis of certain criteria (e.g., user interface or feature set). Further, the ability to launch virtual applications avoids certain problems associated with the prior art, such as resource depletion, performance degradation or conflicts during operation.

There may be intermediate steps involved in the processing of search object(s) and/or search input, and the results may be displayed and updated dynamically in the search interface, as they become available.

Further referring to FIG. 1, in one aspect of the invention, the search engine utility (32) includes an inference engine (34). The inference engine (34) infers one or more probable intentions of one or more users, such as search intention, thereby providing more intuitive and streamlined user workflows, including for example Internet search workflows. In one aspect of the invention, the inference engine (34) is configured to act iteratively on search input selected or provided by one or more users (consisting of one or more search objects) and also interaction of the user with search results (38). The inference engine (34) may be connected to a profile manager (40) that creates and manages profiles (42) for each user, including based on logging of user activities on the computer system (10). A user profile (42) provides additional data sets for inference engine (34) to infer the intent of the user.

In one aspect, the search input utility (26) is responsive to a wide range of search input from users, which are referred to in this disclosure as “search objects”. Search objects may include the following.

(A) Files or File Sets. This means single computer files or groups of files based on a number of collective attributes such as file type, file location or other attributes. In one aspect, the “search object” or “search objects” consist of a plurality of files, where each file is processed in sequence or they are processed together in aggregate (for example based on a comparison of the files). Files may consist of any information object stored to a storage medium, and the inference engine may be implemented to process a wide range of file types and file formats. The files or file sets may be stored to any type of storage medium such as a disk, RAM, database, or cloud-based storage service. (B) Information Organization Structures (that may contain files or file sets, or other information) such as folders, network shares, computer names, network names, domain names, workgroup names, website links, URLs, or other organizational structures defined by IT. (C) Non-static information objects such as data streams. (D) Devices, i.e, named technology components, identified by an identifier, that may be associated with information, including files or file sets, information organization structures, or non-static information objects.

The search engine utility (32) is connected to an index (44) of resources (17) or applications (15) linked to the computer system (10). The resources (17) may include for example different Internet search resources that may be implemented by the search engine utility (32), or may be accessed by the computer system (10) from third party resources implemented to other computer environments. The applications (15) may consist of for example third party computer programs, computer environments, or web services. For example, the resources (17) may include for example: (i) commonly known third-party applications, (ii) scripts or command line procedures, or (iii) web services.

As further explained below, the search engine utility (32) analyzes the search object(s) and any additional search input provided by one or more users to establish aspects of the intentions of the user (for example the user's intent to find certain information, in a particular file format, or to access a particular application to complete a specific task that the user has in mind).

The search engine utility (32) is connected to an index (44) of resources (17) or applications (15) linked to the computer system (10). The resources (17) may include for example different Internet search resources that may be implemented by the search engine utility (32), or may be accessed by the computer system (10) from third party resources implemented to other computer environments. The applications (15) may consist of for example third party computer programs, computer environments, or web services. For example, the resources (17) may include: (i) operating system integrated functions, (ii) commonly known third-party applications, (iii) scripts or command line procedures, or (iv) web services.

As further explained below, the search engine utility (32) analyzes the search object(s), as well as any additional search input provided by one or more users. The search interface (30) may include for example a section that allows a user to provide information regarding their search intent such as their intent to find information related to one or more key words provided, a file format related to files of interest, or information identifying an application that the user wants to user to complete a task.

Therefore, in one aspect of the invention, the search engine utility (32), processes the search input automatically by initiating one or more processes that execute one or more intended operations in relation to the search object, as further explained below. In other words, the computer system (10) automatically applies one or more transformations to the search objects, including based on inference of the user's intent, which may be based on application of one or more probabilistic methods, and access to one or more user profiles.

In contrast to prior art solutions, the inference engine (34): (A) analyzes the search objects and/or additional search input provided by the one or more users; (B) based on the results of the analysis display a set of possible actions.

In one aspect the set of possible actions is accessed from a database (19) that contains a list of actions and associated meta data. The meta data may include data for associating specific actions, using particular applications, for particular search objects/search input. An “action” as used in this disclosure may refer for example to a range of operations that may be applied using one or more applications linked to the computer system. The contents of the database (19) may be enhanced iteratively so as to expand the possible actions and meta data for matching actions to search objects and/or search input.

An example of an action and associated logic for the computer system invoking an action automatically are explained below. (A) An image file of a person is provided as a search object along with the search input “FIX RED EYE”; (B) the computer system analyzes the image file and detects that it is an image of a particular type and format and that it contains a facial component (e.g., detected using a conventional face detection technique) and that it may include a red-eye, and other attributes may be defined as well; and (C) the computer system accesses the database and obtains a list of possible actions available for images, including “FIX RED EYE” using a particular application for this purpose. In one aspect, the computer system displays information objects identifying a plurality of possible actions, in a way that allows a user to select the action that is associated with their intent, or is closest to their intent. Additionally, the actions provided may be exhaustive (e.g., all possible actions for a given object type) and may include actions that are peripheral to the user's intent.

In one aspect, the computer system determines an entire set of possible actions based on analysis of the search object. Additional search input provided by the user may be used to narrow the list of possible actions suggested by the computer system. Alternatively, the full list of possible actions may be ranked using search input, using one or more suitable ranking mechanisms. Actions that represent the closest matches, based for example on the words or phrases provided as search input by the user, may for example be ranked more highly than other identified actions in a list of suggested actions.

The actions are displayed as fully realized image processed results (i.e., the original image processed to remove red-eye), or displayed as virtual image-editing applications pre-loaded with the original image, or displayed as a web-service image-editing application within a browser window. All results are provided simultaneously to allow for comparative review by the user and selection of the desired (best) result.

Results (or actions) may appear as they are ready and available for review. More results (or actions) may be available than can be viewed at one time. So, according to one aspect, results “pop” into display for user review in an appropriate visual presentation and ordered and sorted according to the user's desired display criteria.

In another aspect of the invention, the user then selects one or more desired actions. The selection of one or more desired actions may be considered by the computer system as a successful match. Particulars of successful matches may be logged by the computer system for example by storing meta data based on the selection, and associated search objects and search input, in order to train the computer system. The computer system may implement one or more utilities for matching search objects and search input to suggested actions, and improving the matching results over time. Various machine learning algorithms and processes may be implemented to the computer system for this purpose.

In one aspect of the present invention, the computer system may include a central computer, or network of computers, enable aggregation of parameters for successful matches across a plurality of linked computer systems.

In one aspect, search objects may be mapped by the inference engine (34) to textual phrases included in search input using object-to-text translators. For example, analysis of a search object comprising a word processor file may return textual phrases associated with one or more file attributes of the search project. The word processor file may consist of a legacy word processor file, where analysis thereof by the computer system, returns the following terms: (i) WORDPERFECT 4.0, (ii) DOS Version, and (iii) LIBWPD Compatible. The returned terms may be used to supplement the database (19) with further related terms from a third party. Internet search service such as GOOGLE™.

The inference engine (34) in one aspect, analyzes search objects, including based on the following parameters, if applicable: (A) analysis of the search object to identify file type, if applicable; (B) analysis of file size; (C) analysis of specific attributes that may be indicative of user intent such as attributes that fall outside of expected ranges; and (D) other attributes associated with the search objects such as: (i) file storage context (e.g. whether a file resides on an “images hard drive folder”), (ii) file name; (iii) file extension; (iv) file header; (v) file system attributes (e.g. attributes stored by an operating system such as size, date, etc.); (vi) file content attributes (such as content fields or tags that may be associated with a file); and (vii) high level file structures recognized by operating system sub-systems.

The inference engine (34) may therefore incorporate or link to a series of applications for (A) discovering one or more first level attributes of each search object (such as a file type), and based on the first level attributes (B) accessing one or more relevant applications or computer resources linked to the search engine utility (32) for further analyzing the search object for second level or more detailed attributes.

In another aspect of the invention, the computer system (10) includes an application access manager (40) that creates one or more links to functionality of applications (15), in order to enable the execution of a search object, or part of a search object, using a relevant application (15), as determined by operation of the inference engine (34). Depending on the relevant application (15), or specific feature of an application (15), and also the manner in which the application (15) is implemented or made available (i.e. whether it is a cloud resource, a client computer program, a web application feature etc.), the application access manager (40) creates an appropriate connection to application (15) features which may include: (A) accessing an application programming interface (“API”) (48) for accessing an application or application resource; (B) logging into a remote server or cloud resource; (C) creating a virtual instance of a computer environment, as a standalone machine (“virtual machine”), or segmenting a portion of a computer environment to host a single application (“virtual application”) (referred to collectively as a “virtualization”), or (D) initiating standardized machine-to-machine interfaces for query and data interchange. In one possible implementation, the computer environment (12) includes a virtualization server (50) for initiating the creation and management of virtualizations.

In one aspect, the application access manager (40), based on the results from the inference engine (34) initiates the access to relevant applications (15), using one or more of the methods previously described.

In another aspect of the invention, the search input utility (36) is presented as a dynamic and flexible GUI that allows a user to select one or more search objects of a variety of different types, based on a series of intuitive and easy to use workflows. FIG. 4 illustrates a possible configuration of search interface (30) associated with the search input utility (36).

In one aspect of the present invention, the following describes a possible user workflow based on interaction of a user with the search interface (30):

the user provides a one or more search objects;

the computer system analyzes the search objects and invokes the inference engine, generating search object analysis data;

optionally the inference engine accesses a user profile for the user (if one exists) and uses the search object analysis data and the user profile to infer intent of the user, if sufficient data exists;

transforming one or more of the search objects based on the inferred user intent;

adapting the search interface based on the inferred user intent; and

optionally further transforming search objects or further adapting the search interface, based further provision of search objects, and interaction of the user with one or more features of the search interface. Further examples are provided below, however it is useful to provide a high level example of how a user would interact with the features of the search engine utility (32), and how the inference engine (34) makes inferences regarding a user's intent, and adapts the system workflow based on these inferences.

The inference engine (34) may detect that a search object consists of a photo (first level attribute), and based on this accesses one or more applications for analyzing the photo, and based on this detects that there is red eye in the photo or the user may provide search input that there is facial component and “red eye” (second level attribute). This information is used by the inference engine (34) to generate an inference, in this example that the user may intend to fix the red eye in the photo—among the many other functions that may be performed on the image.

In another aspect of the invention, the server application (20) includes or is linked to a logger that logs and stores to a database (19) data based on actions of each user. The server application (20) may also include a profile manager (40) that organizes data based on actions of the user to construct a user search profile (42). The user search profile (42) records information regarding the user's search history, which in the context of the platform (10) also includes information based on sequences of actions of the user. For example, the user search profile (42) may be based in part on the following sequence: (A) search objects provided by the user (whether for example a string of search terms or one or more files imported to the search interface, (B) specific applications (15) that the user may have accessed relative to the search objects, (C) specific operations that the user may have accessed from these applications (15). A skilled reader will understand that prior art solutions have not analyzed sequences of search objects and user selections related to transformation using the search object as a mechanism of inferring user intent.

These aspects of the user search profile (42) enhance the ability of the platform (10) to infer intent of the user, thus for example reducing the number of steps required for a user to access for example desired functionality.

The profile manager (40) may be linked to an analytics utility (52) in order to analyze information regarding the user's search history in order to extract inferences or insights. For example, the analytics utility (52) may enable the platform (10) to analyze frequency of a user engaging in certain profiles; applying “next best step analysis” based on a probability analysis of next steps in a given sequence based on next steps taken by other users, including for example users with a “similar” user search profile.

In another aspect of the invention, the search interface (30) is configured in order to display certain aspects of the inferences being made by the platform (10) regarding the user's intent. Generally speaking, in prior art solutions, these inferences may be guessed at by a user, but are not revealed. One aspect of the invention, the web presentment utility (22), displays the inferences made by the platform (10). This allows the user to provide additional input to iterative search/transformation processes of the platform (10). This may include the user providing additional search objects, or interacting with the search interface by making one or more selections indicative of user intent.

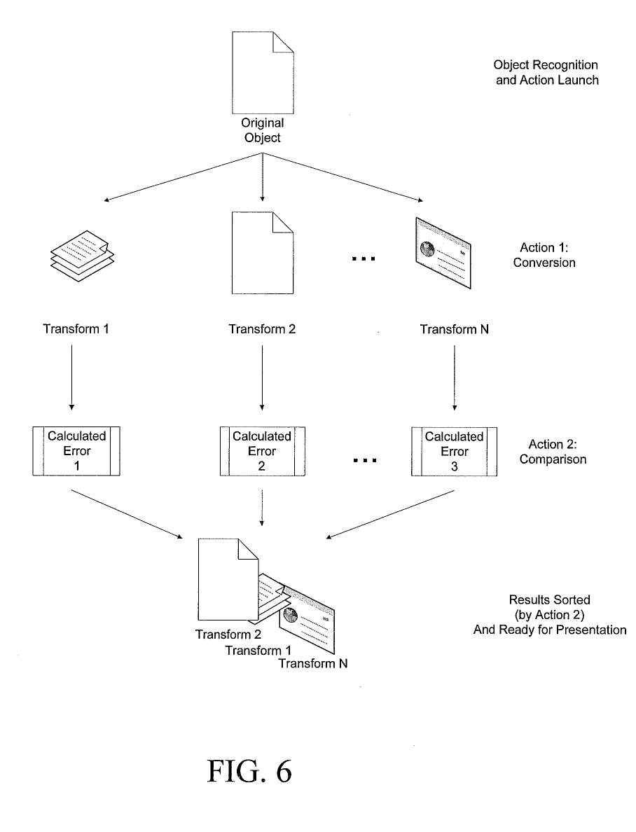

In one possible implementation, the computer system (10) incorporates parallel processing functionality. This extends to processing of search objects, including inferring user intent, display of applications and associated transformations. This may result in chaining of actions, as illustrated in FIG. 6.

The computer system is designed to enable users to engage in a wide variety of activities. The word “search” is used broadly to include activities that may include a search function, but where searching for particular information is not the object. For example, and as previously described, the computer system (10) allows a user to submit a particular information object, such as a photo, and the computer system based on the submission and other information relevant to the information object or the user, commences processing of the photo using one or more application relevant application (15).

### Further Details of Implementation

Various computer system architectures may be used to implement the computer system and computer implemented methods of the present invention. For example the system may be implemented using a client/server architecture, where the functionality described is implemented to a server application, accessed by multiple users from their computer devices, whether these are a desktop computer, a laptop computer, a tablet computer, a netbook or a smart phone. Various distributed computer architectures may be used, and the features described herein may be implemented as cloud networking solution.

In one possible implementation, the platform may be implemented using a web software application that can run on any desktop or mobile computing device that supports modern HTML5 and extendable interfaces for running remote applications on local desktops, servers, network computers, clusters or in the cloud. The back-end of the platform may be implemented using for example MICROSOFT™ software services, Powershell V3.0 scripting, Microsoft Operating systems (Server 2012, Server 2008 R2, Windows 7, Windows 8), IIS, High Performance Computing (HPC) Pack 2012, Hardware Clustering Support, MICROSOFT HYPER-V, APP-V, VDI, AZURE cloud services, and other MICROSOFT services and infrastructure. Other Internet applications and services may be used.

One aspect of the implementation of the invention is that the platform combines an advanced web browser interface for accessing search functions with virtualized applications running on networked servers combined with cloud processing. This enables support of non-local operating system version of applications and provides access to scale by leveraging of cloud resources.

Examples of software to enable software virtualization include APP-V™ of Microsoft Corporation, or Thinapp™ of VMWARE. In addition, CAMEYO™ allows applications to be virtualized and moved from computer system to computer system.

Another aspect of the implementation of the invention is that the platform combines a client application to assist in the processing of actions using local resources and presentation of such results. Examples of such thin client software are conventional Windows™ desktop/tablet applications written in standard programming languages, or various web browser apps such as Chrome Apps.

It should be understood that in this disclosure the word “application” or “app” may be used generally to describe processing functionality that is linked to the computer system of the present invention but may be implemented in a number of ways including as a computer program, server program, client computer program, operating system, Internet service, cloud service etc.

This architecture also allows the support of legacy file formats, legacy objects, obscure objects and niche objects, which expands the scope of possible search objects.

In one aspect, the platform is implemented so as to enable the finding of scripts and application for executing operations matched for search objects/search input. In one aspect, the platform executes operations by launching live windows with virtual applications loaded, as part of the search interface.

Accordingly search results as described are, in one implementation, actually instantiated solutions. This obviates the need to download applications, install them and test them. Functionality can be tried much more efficiently. This provides opportunities to vendors to showcase their technology to a broader audience, and in a more intelligent way.

In another possible aspect of implementation of the invention, the operator of the platform vets applications, and registers to the platform only those applications that meet one or more qualitative criteria. This provides further benefit to users by allowing them to access an environment where functionality is curated.

In another aspect of the invention a preferences utility can be provided to users so that they can define one or more parameters for filtering the applications that are presented for their use. In one aspect, a ranking mechanism may be implemented to the platform, which may include a rating system; users may define one or more filters based on ratings for all applications or application types that are presented to them in connection with search results.

Various instant of actions may be implemented by the platform. The actions may be of varying complexity, and may be relatively instantaneous or may require a significant delay to complete. They can involve user interaction or be implemented using automated or semi-automated processes e.g. processes: invoked by scripts, command-line syntax or simulated user input to an interactive application. Some example types of actions include: (i) analysis for improvement in understanding of the object; (ii) a comparative analysis among other objects; (iii) testing against a set of criteria (e.g. standards compliance etc.); (iv) transformation of objects into new objects; and (v) instantiation of virtual desktops & machines to host (virtual) application actions.

More specific examples of actions that may be suggested by the platform include: (i) given a computer-name on a network, the computer system provides an IT parameter such as a number of CPU cores or number of users currently logged in, etc.; (ii) given a text file, the computer provides the number of words in the file that may be offensive in a certain cultural context; (iii) given an EXCEL™ file, the computer system provides reasonably comprehensive view of all graphing or charting function of the current sheet; (iv) given a search term, the computer system provides results across a plurality of search engines and web-entities and returns cross-matched references; or (v) given a collection of media files, the computer system encodes the media files into a revised format and provides a comparison of all output for quality and size metrics.

The number and complexity of actions executed by the computer system may only be limited by the skills of the implementer and the knowledge base from which the action is taken (or created).

In one aspect, actions may also be chained such that the output from one action becomes the input to another action. In this way, multiple actions may be used to transform an object sequentially or in an order-dependent manner guided by keywords or automatic processes. For example, as shown in FIG. 6, a first action may be a transformation or conversion action and a second action may be a comparison action that evaluates the accuracy of the first action. As shown, at each stage, multiple actions (e.g., multiple transformation actions or multiple comparison actions) may be performed in parallel to form multiple chains. The end results of each chain may be sorted according to pre-defined criteria and presented to the user for review.

In one aspect of the present invention therefore the end product of the platform may be a chain of actions. For example, depending on the actions applied, a result may be in human readable form or may include new object(s) or an application window result pending further operator intervention. Human readable results may include textual reports, graphs or charts, comparisons, program displays, etc. New objects may include transformations of the source objects or creation of new objects. Application window results may include virtual applications initiated with the object but held in stasis pending further interaction or control from the user.

Further examples of possible results may include: (i) textual summaries as you would expect from a simple command designating the result, (ii) generation of a summary of high level object or child objects; (iii) a grid or table of displayed summaries to provide richer graphical output; (iv) resulting new objects may include for example files, folders, or streams, that can be viewed or displayed; or (v) instantiation of high level objects using computers, applications, or virtual machine or device technology.

The actions suggested by the computer system may be a “preview” of results based on a particular application, and feedback may be logged from one or more users so as to initiate one or more operations based on the particular application. Typically, the computer system returns multiple (many) results, and these may be reviewed simultaneously in a tabbed or otherwise free-form multi-window format. Each result may be hosted in a locally produced window, or in a virtual environment (hosted locally or remotely).

In one aspect, one or more results may be presented by a virtual environment consisting of an execution environment that simulates an entire operating-system as a standalone machine (a Virtual Machine or VM) or segments a portion of an execution environment to host a single application (a Virtual Application or VA). In either case, the user may be provided with a sandbox where they may work with a live copy of the particular application, securely isolated from their own hardware, with no risks to their own equipment (or the equipment of the provider). Virtual environments provide a safe location to test new software without requiring the User to have the knowledge (or time) required to install, configure and/or remove the application that they may be looking for. Virtual environments may be hosted by the solution provider, third party partners, cloud service companies, or even downloaded and executed on the user's own hardware.

The present invention addresses the fact that many users have limited knowledge of available technology, software, and solutions. Users may wish to complete a job in an efficient manner but may lack knowledge of how to access relevant features from an application. Further, users may understand that “Apps” are the ordinary means to affect actions on data objects but they may not know the names of the apps.

One aspect of the present invention, is that a direct link to a relevant feature is provided, and one or more operations related to an application are executed by the computer system automatically. Therefore, the user does not need to know the system workflows associated with a relevant application.

Software/tools required for a task may be installed on the user's system but s/he may not be fully aware of its capabilities or how to access the required function. Alternatively, the software/tools may not be installed, available, or even known.

This disclosure teaches that instead of assuming the user has a priori knowledge and operating on a text string descriptive of an object and associated problem/solution in a search engine to find applications or a means to a solution to a problem, a better approach is to act based on an object provided by the User and provide all possible actions, possibly even actions unknown to the user.

As the user selects an object, this approach provides all possible operations on that object based on the characteristics of the object, the users' profile and action selection history, and an overall aggregate frequency of the action selection across all users.

The computer system of the present invention generates results based on the type of object selected by the user. The user does not need to know about the various characteristics of the object itself, only the end result they are looking for (guiding the computer system toward a solution set). One advantage of the present invention is that computer system incorporates logic required to recognize an object and perform an appropriate action based on the user's request. The server application (20) may implement a series of rules as to which applications or Internet services are applicable in what circumstances, and how to transform objects using these applications or Internet services.

A skilled reader will appreciate that applications or Internet services may relate to a wide range of categories such as productivity, entertainment, workflow, creative, social, personal health, etc. In one possible implementation of the present invention, applications and Internet services of interest in implementing the present invention may include any applications or Internet services that have a defined and described purpose (in the commercial sense) to process, transform, or otherwise affect or interact with a data object. They prescribe an “input” data object, apply an “action” and produce an “output” or “result”. The applications or Internet services may require directed user interaction with a user interface or their operation may be automatic or controlled with command-line switches.

In one aspect, knowledge of object types, characteristics, and descriptions as well as the actions that may be performed are stored in a database. The database may be local, or may be accessible remotely, over the Internet. In either case, the database may be updated from time to time as new object types and actions are added. The database may also “piggyback” on existing search engines and drill down to the required level of the software application of Internet service—mapping the search keywords to named menu items. The database may also be moderated through user input and allow contributions from the developer and user community.

The database allows the program to suggest actions based on a combination of the following metrics:

Past User actions—for the selected object, the most commonly used action is X.

Community—members of the community commonly use a particular application or Internet service, or action, or have created (and popularized) their own application, Internet service or action.

Expert evaluation—applications are evaluated by the moderator, and related actions are created and tested.

Paid commercial actions and sponsored applications may be used, where third party vendors have the opportunity to promote their application and associated processing functionality.

Execution cost, a metric based on the costs of Bandwidth, CPU cycles, Time. This metric could be summarized as the resource cost to the User and/or the Provider to process a given action.

These metrics may be combined and used to create a ranking mechanism. This allows the computer system to determine which actions can be run automatically (low cost, frequently use) versus those that might have to be specifically selected by the User. The metrics also determine the presentation order of the actions once an object has been entered into the interface.

In addition to action metrics, the database may also contain a library of object recognition characteristics (fingerprints), action scripts (either developed by the operator of the computer system or a wider community), and applications. In one aspect, applications are not included in binary form (the resulting database would be quite large), rather the database stores links to the location of applications (and/or the scripts required to start the VE sandbox to hold a particular application).

Given the amount of objects, scripts and links that the database may contain, the database may become very large. To address usability concerns (mainly due to speed of local access and storage requirements), the computer system may download from time to time a subset of the database. A most frequently used segment is initially determined by a user's profile, and allowed to evolve over time. This local database is used as a local cache of the main database, allowing a fast response time for most requests, with occasional delays caused when an object requires downloading a portion of the main database for recognition/processing.

When an object is selected for processing, the computer system consults the database and, based on the recognized type, proposes a list of possible actions that could be applied. The list of actions could be further filtered with additional text if required to reduce the number of found actions to a manageable level. The computer system in one aspect may automatically recognize an object by its format, standard, and/or profile based on the characteristics (file header signature) or a predefined format (e.g. file name extension). Further classifications may be drawn from the operating system or the Internet. Once an object is recognized, the computer system presents a list of possible actions to the user in a user interface. Actions that are commonly used or require low CPU cost may be started automatically. Actions that are time-consuming or high-complexity may await user initiation.

The user selects one or more additional actions from the list presented by the computer system. Actions:

May be executed locally, using local resources (e.g. searching the local network) or remotely, with only the results being returned.

May be simple, single step commands, or complicated scripts which encompass a number of steps.

May be executed in parallel (e.g. a search of the local system at the same time as the search is performed on a remote server or in the cloud).

May have their own ranking system based on a one or more factors such as user preferences and skill-level, the (recommendations of the) wider community, and internal experts. This allows the computer system to recommend/suggest an appropriate action before the User needs to think/make a decision.

May be prioritized based on metrics related to cost, bandwidth, processing requirements, and other characteristics.

May be chained—the output from one action becomes the input to another. This chaining may have many links.

Once one or more actions may be selected by user, which initiates the computer system to begin processing the request, starting one or more processes (as a virtual environments (VE's), background processes, or scripts) for each action. Each of these actions runs in serial or parallel fashion, depending on the available resources.

Commonly used actions, when gauged across the entirety of users accessing the platform, may be pre-executed or pre-loaded and pre-associated with virtual environments to assist in performance and responsiveness to the user.

The status of each action may be displayed in an associated results window—showing completion, health, resources, current results (where possible), and other dashboard-like indicators. When the actions complete, selecting their summary indicator in the result window opens a window to display the full results of the action. The window may open a text or graphics display, it may open onto a process on the local machine, a VE on the local machine, or a remote access desktop to a VE on another machine either on the local network or, in some instances, allocated from a cloud provider. In some cases, the computer system may apply an overlay to the window designed to coach the user through the process of transforming their object. The overlay may also display messages and/or advertising as a means to support the operation of the service. Alternatively, the overlay may be restrictive, in the manner of a visual watermark for example, to protect the application publisher when the action is an evaluation or trial version of a commercial application.

Actions may be configured to send a notification message to the User when they complete and/or ready for review. This is particularly useful in circumstances where an action requires a significant amount of time to finish (e.g. conversion of a series of video files to an new format). In one implementation, the notification message may consist of an email, a SMS text message, or the like.

The server computing environment (12) may be configured to prepare and launch a plurality of virtual environments (VE's), one for each application that is to act on the object. VE's are used for a number of reasons:

Lower cost to implement versus hosting a compete virtual machine.

Increased security—not providing an open environment means the user's home environment is not exposed to undesirable effects of an application. Third party vendors are also more secure as their equipment isn't exposed to potential abuse from the wider Internet.

Ease of use—controlled access to limit the user's options, meaning they can get their job done with fewer distractions/complications.

Each VE may constitute in effect a private sandbox where the user may inspect the result and/or continue to explore the application and/or associated data transformations. There is no risk to the security of the user's own system, nor are they required to work out the details of how to install and/or remove the application. This allows the platform to provide ‘What-If’ scenarios to the user—allowing risk-free trials of commercial and open source software.

Commercial partners of the platform may choose to host their own applications in their own VE's. In this case, the database contains the information required to launch the VE within the partner's infrastructure. The partner may be responsible for maintaining their own resources and the operator of the platform provides initial access and promotion (through the system of metrics discussed previously). In this manner, the commercial partner is ‘marketing’ their solution by making available the CPU and bandwidth resources available for sample usage.

While the exemplary implementation uses primarily virtualized applications, a similar functionality can be provided using virtual machine instances (VMs) at much higher cost, complexity, and security risk. Alternatively, implementations involving only script-file or operating system command actions may be executed entirely on the user's local computer or device if the program determines that it is more cost- and time-effective to do so.

VE hosted applications reduce or eliminate risks (due to piracy, user error, etc.) to the commercial vendor—the user never needs to download the application binary. Users may only have access to the application through the VE via a remote desktop-like application for use/testing purposes, and depending on licensing may have to pay to download or rent additional access.

Results may be organized by both internal (to the search functionality of the present invention) and external (the results of the action) statistics. For instance, in the case of an image based action, the results may be sorted by the user community's feedback on the performance of the various image related tools that may be applied. In the case of a simple text based search, the results may be sorted by the actual search engine's ranking, weighted further by the community's preference for a particular search engine.

Results may be returned as a summarized list of possible solutions to the user's query, with each entry in the list linked to more information and/or the actual VE itself. In the simple case where the query is a text string that returns search engine results, the links may open new windows containing the linked (Internet) content. The data for these windows may be pre-fetched to improve the searching experience. In a more advanced case, the results are returned in a set of virtual environments, each one containing a possible result of the query. For instance, in the case of an image manipulation query, the program might start a number of VE's, each one containing a different image manipulation software package loaded with the image in question. Upon completion, each VE contains the modified image and may also hold a live (operable) copy of the App in case the User wishes to experiment further.

Results may be paired with supplemental information taken from the Internet (additional search results), community feedback and internal ranking. Results may also be paired with commercial advertising and product promotions.

The present invention utilizes high performance processing, abundant memory, and networked clustered computers for high performance computing, cloud computing and storage and high speed file transfer in order to provide a novel and innovative approach to object oriented workflow.

### Representative User Workflow

A representative user workflow is described with reference to the blocks depicted in FIG. 5.

A user identifies need to act on an object, but may be uncertain of how to proceed for example because of lack of knowledge of application required, or how to use the application to engage in a required action.

At block (500), a user provides an object (or a representative example object to “test” the capabilities of the system). For example, the user selects a file from a file viewer, drags and drops a file, selects a device from a directory, selects a web URL (for streaming), and/or makes text entry of any associated keywords or filter terms in order to provide search input. These filter terms may be clarifications related to the object (i.e.—specific functionality) or filters related to the narrowing of the results (i.e.—show only scripts, or only ‘free’ applications), etc.

At block (502), the computer system initiates object recognition by analyzing the object. For example, the computer system may analyze the object to determine whether it is text, whether it is of a known object type, whether it matches a known format or fingerprint. If the object is not a known object type, at block (504), the computer system may update the local content database to include the new object type with characteristics (e.g., fingerprint), as analyzed.

At block (508), the computer system suggests a list of actions, and may enable the user to filter the list of actions (block 510) based on need, e.g., according to text input.

While the user is looking at the list, based on a set of associated rules, one or more of the actions may be pre-started (anticipated). The rules may be based on previous actions of the user, the community, the type of object and the central database. Alternatively, based on these rules certain actions may be applied automatically (block 506).

The user may select one or more additional actions to run, as determined at block (512).

At block (514), actions may be run in serial or parallel fashion, launching processes (background scripts, downloaded local a virtual environments, or remote virtual environments) as required.

Results start to appear immediately. Actions of greater complexity may take longer. At block (516), status of each action may be displayed in the results collection (25% complete . . . ), as shown at (400) of FIG. 4. Notifications may be sent on completion of individual or all actions. Notifications are particularly important for actions that require an extended period of time to complete. The user may be free to continue with other tasks, returning only when they receive notification of completion.

Results may be collected (and sorted) into a summary view—a live view of the status of each action being executed (e.g., at 402 of FIG. 4).

At block (518), the user may select results to view or act on, which opens a window into one of the virtual environments/sandbox where they may continue to experiment with the results.

User may elect to apply an action to one or more additional objects (allows for trial followed by purchase/subscription).

As illustrated in FIG. 4, the search interface of the present invention, may be configured to include three sections: (A) an object input and settings area; (B) an action review and selection area; and (C) a results summary and selection area. The search interface may be implemented as an “always live”, stateless dashboard that does not require an “apply” or “go” button. Any modifications or updates to any of the section may cause the program to update other windows in support of the modifications or updates.

Further details are now provided for the search interface areas.

The object input and settings area, in one implementation, plays two main roles: (i) it allows the user to select an object, and (ii) set text keyword modifiers to guide the computer system toward a solution set. The area can support drag/drop and copy/paste functions from outside the search interface.

Objects can be singular or multiple. If multiple, the search interface can modify the meaning to either run the search across all child objects or run the search with the parent object. A further section of the area can allow the addition of keyword modifiers or selection of one or more categories. This section may be implemented using standard text entry or dynamic zones that adjust the list of keywords based on the objects, and using searches applied to the search database.

The action review and selection area may include suggestions of possible action based on the search objects and search input. In one aspect, the list may be a short list and may be a categorization of the results summaries.

The results summary or details area consists of a panel that may include a tabbed window containing a textual summary view of action results or a pictorial view of the output of the action. Clicking on a summary item (text or pictorial) brings up a separate window. The separate window may provide for example: (A) a view of the STDOUT text of the action execution; (B) a viewable/playable media object (image, video, audio); (C) a fully operational virtual application window; (D) a widget from any of a variety of web services; or (E) a link to a web page(s).

In another aspect, hovering over a summary item may trigger a pop-up in the results window preview (larger pictorial).

The search interface may also include engagement and community features for providing feedback regarding functionality, engaging with other platform users, and submitting solutions to the platform for sharing with the community of users linked to the platform.

According to one aspect of the present invention, the systems and methods described herein may be used by users to discover and apply functions and features from an older computer system environment in a new computer system environment. The new environment may include a different operating system, or may not include any “operating system” per se. Further, the new environment may not be operable through commands or applications familiar to the user. So, the present invention provides assistance to migrate the user to the new environment, and to familiarize the user with commands and functions of the new environment. Productivity is thereby improved.

According to another aspect of the present invention, the systems and methods described herein may by users to access legacy files, and recover content therefrom. Modern applications often do not support legacy files. For example, older format office, financial, engineering, media, or specialized commercial files often require the original software running on the original operating system. It may be difficult to provide such original software on original operating systems on modern devices and computers. Hence valuable content is sometimes “trapped” in older files, requiring specialized and costly IT resources to recover. The present invention simplifies the process. In particular, it provides systems and methods for hosting virtual environments to run the legacy software and displaying the results and instantiations associate therewith on modern platforms.

According to another aspect of the present invention, the systems and methods described herein may be used to access files stored in the cloud, as may be commonplace in enterprise and personal computing environments/domains. References to data objects in cloud-based storage (e.g., in the form of a URL or similar identifier) can be directly linked and utilized by the cloud-based compute resources disclosed herein. Conveniently, this allows even large data objects (such as, e.g., 4K home movie files) to be practically used without the prohibitive cost and time to transfer data objects between cloud and local based storage.

### Advantages

Various advantages of the present invention have already mentioned above. Further advantages are described.

The platform provides an easy to setup and configure, easy to understand, natural search interface. Results appear quickly, thus providing a more engaging user experience. A rich, virtualized application experience is provided in an intuitive manner.

By combining a new search method with intelligent matching of search input to application functionality, the present invention provides a useful and innovative way to discover and access relevant applications.

Efficiency of Internet search and application discovery is improved, and computational resources required for Internet search and application discovery may thereby be reduced.

Migration of data processing to the cloud is made more convenient and practical by leveraging virtual computer resources while providing a system, method and platform that retains software solutions in a virtual environment to maintain data objects created and stored by users.

The platform represents a significant innovation to Internet search and also application discovery.

The methods described herein can be implemented by computer-executable instructions stored on one or more computer-readable media or conveyed by a signal of any suitable type. The methods can be implemented at least in part manually. The steps of the methods can be, implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

The present invention may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

While the above description provides examples of one or more embodiments of the invention, it will be appreciated that numerous other embodiments may be within the scope of the present invention, as defined by the following claims.

1. An Internet search computer system comprising:
a. a computer network service environment, comprising at least one server computer and a server application, the server computer being configured to process Internet search requests from one or more client devices, the computer network service environment comprising:
(i) a search input utility that initiates the presentation on a display linked to a client device of a search interface; the search input utility allowing one or more users to select one or more search objects; and
(ii) a search engine utility configured to iteratively process the search objects so as to identify a plurality of suggested actions that are responsive to the search objects, for further selection by the one or more users, the computer network service environment being configured to initiate the automatic processing of the search objects, and iteratively update suggested actions with the results of such processing.

2. The computer system of claim 1, wherein the computer network service environment presents the actions in a plurality of sections of the search interface.

3. The computer system of claim 1, wherein the search input utility is configured to collect search input from the one or more users, and wherein search engine utility is configured to process the search objects and search input to identify the plurality of suggested actions, and wherein the computer network service is configured to initiate automatic processing of the search objects and the search input.

4. The computer system of claim 2, wherein the computer network service environment is linked to an application repository, and the computer network service environment processes the search objects and search input so as to select one or more applications from the application repository for processing the search objects and search input and providing results responsive to the Internet search requests.

5. The computer system of claim 2, wherein the computer network service environment matches the search objects and/or search input to applications.

6. The computer system of claim 2, wherein the computer network service environment matches the search objects and/or search input to specific features of applications.

7. The computer system of claim 1, wherein the computer network service includes resources to virtualize one or more applications for presenting the results.

8. The computer system of claim 1, wherein the computer network service environment performs at least one action of the plurality of suggested actions.

9. The computer system of claim 8, wherein the computer network service environment performs the at least one action in response to a user section of that at least one action.

10. The computer system of claim 8, wherein the computer network service environment performs the at least one action automatically.

11. The computer system of claim 8, wherein the computer network service environment performs actions of the plurality of suggested actions according to a pre-defined sequence.

12. The computer system of claim 8, wherein the computer network service environment performs actions of the plurality of suggested actions in parallel.

13. The computer system of claim 8, wherein the computer network service environment presents an output of performing the at least one action to the one or more users.

14. The computer system of claim 2, wherein the search engine utility comprises an inference engine configured to process the search objects and/or search input to infer a probable intention of the one or more users.

15. The computer system of claim 1, wherein the search objects include at least one of a computer file, a set of computer files, an information organization structure, a data stream, and an identifier of device.

16. The computer system of claim 1, wherein the search engine utility is configured to process search input that specifies a desired operation to be performed on the at least one of the search objects.

17. The computer system of claim 15, wherein the search engine utility processes a search object that is a computer file by analyzing at least one of: a file type, a file size, a file storage location, a file name, a file extension, a file header, and a file system attribute.

18. A computer-implemented method of performing an Internet search, the method comprising:
receiving, at at least one processor, a request to conduct an Internet search from a client device;
presenting, to the client device, a user interface allowing a user to select one or more search objects;
receiving a user selection of the one or more search objects;
iteratively processing, at the at least one processor, the selected search objects to identify a plurality of suggested actions that are responsive to the search objects; and
presenting, to the client device, a user interface allowing the user to select one or more of the plurality of suggested actions.

19. The computer-implemented method of claim 18, further comprising:
receiving user input associated with the one or more search objects;
wherein identifying the plurality of suggested actions comprises processing the received user input.

20. The computer-implemented method of claim 18, wherein the search objects include at least one of a computer file, a set of computer files, an information organization structure, a data stream, and an identifier of device.

21. The computer-implemented method of claim 18, wherein the processing comprises inferring a probable intention of the one or more users.

22. The computer-implemented method of claim 18, further comprising:
performing the selected one or more actions of the plurality of suggested actions.

23. The computer-implemented method of claim 22, further comprising: presenting, to the client device, an output of performing the selected one or more actions.
